(19) United States
(12) Patent Application Publication
(10) Pub. No.: US 2022/0092457 A1
(43) Pub. Date: Mar. 24, 2022

(54) ELECTRONIC DEVICE AND METHOD FOR ANALYZING RELIABILITY OF FACILITY

(71) Applicant: SHENZHENSHI YUZHAN PRECISION TECHNOLOGY CO., LTD., Shenzhen (CN)

(72) Inventors: Yi-Chen Lu, New Taipei (TW); Chen-Ting Wu, New Taipei (TW); Cheng-Lun Lee, New Taipei (TW)

(21) Appl. No.: 17/481,455

(22) Filed: Sep. 22, 2021

(30) Foreign Application Priority Data
Sep. 22, 2020 (CN) 202011005521.8

(51) Int. Cl. G06N 7/00; G01M 99/00

(52) U.S. Cl. CPC G06N 7/005; G06N 3/084; G01M 99/005

(57) ABSTRACT

A method for analyzing reliability of facility implemented in an electronic device. The method includes obtaining alarm data from at least one equipment; generating a first prediction parameter and a first algorithm model based on the alarm data and a first model; generating a second prediction parameter and a second algorithm model based on the alarm data and a second model; determining that the first algorithm model is better than the second algorithm model based on a judgment model, the first prediction parameter, and the second prediction parameter; and generating an evaluation index based on the first algorithm model, so as to evaluate the reliability of the at least one equipment based on the evaluation index, when the first algorithm model is determined to be better than the second algorithm model.

### CROSS-REFERENCE TO RELATED APPLICATIONS

This application claims priority to Chinese Patent Application No. 202011005521.8 filed on Sep. 22, 2020, the contents of which are incorporated by reference herein.

### FIELD

The subject matter herein generally relates to facility analysis, and particularly to an electronic device and a method for analyzing reliability of facility.

### BACKGROUND

Factory equipment, such as fixtures, can issue an alarm when a fault occurs, to warn operators. In order to facilitate management of the equipment, it is necessary to evaluate and analyze reliability of facility based on alarm information. A single probability distribution model is usually configured to estimate reliability information of equipment. However, it is easy to cause model mismatch problems if only the single probability distribution model is used for estimation, which may result in mis-estimation, and thus reduce credibility of the estimation of reliability.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of an embodiment of an application environment of an electronic device configured to analyze reliability of facility.

FIG. 2 is a block diagram of an embodiment of an electronic device configured to analyze reliability of facility.

FIG. 3 is a functional block diagram of an embodiment of a facility reliability analysis system.

FIG. 4 illustrates a flowchart of an embodiment of a method for analyzing reliability of facility.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or another storage device. Some non-limiting examples of non-transitory computer-readable media include CDs, DVDs, BLU-RAY, flash memory, and hard disk drives. The term “comprising” means “including, but not necessarily limited to”; it in detail indicates open-ended inclusion or membership in a so-described combination, group, series, and the like.

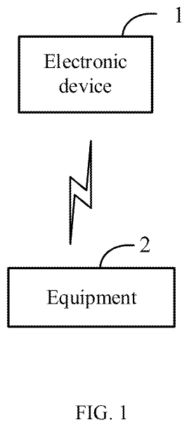

Referring to FIG. 1, an electronic device (electronic device 1) is illustrated. A method for analyzing reliability of facility is applied in the electronic device 1. The electronic device 1 can communicate with at least one equipment 2 through a network. As illustrated in the present disclosure, the term “communicator” can refer to any type of communication circuit or device. The communicator can include several types of network elements, such as base stations, routers, switches, servers, aggregators, bus architectures, a combination of the foregoing, or the like. One or more bus architectures may include industrial bus architectures, such as Ethernet-based industrial buses, controller area network (CAN) buses, Modbus protocols, or other types of field bus architectures. The network can be a wired network or a wireless network, such as Internet, WI-FI, and cellular network.

In one embodiment, the electronic device 1 can run a facility reliability analysis program. The electronic device 1 can be a personal computer or a server. The equipment 2 can be a manufactured device or a testing device.

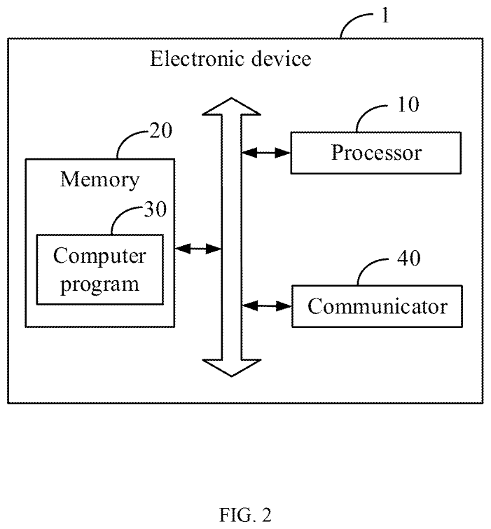

FIG. 2 illustrates the electronic device 1 in one embodiment. The electronic device 1 includes, but is not limited to, a processor 10, a memory 20, a computer program 30, and a communicator 40. The computer program 30 can be the facility reliability analysis program. The processor 10 executes the computer program 30 for implementing the method for analyzing reliability of facility. FIG. 2 illustrates only one example of the electronic device 1. Other examples can include more or fewer components than as illustrated or have a different configuration of the various components in other embodiments.

The processor 10 can be a central processing unit (CPU), a microprocessor, or other data processor chip that performs functions in the electronic device 1.

In one embodiment, the memory 20 can include various types of non-transitory computer-readable storage mediums. For example, the memory 20 can be an internal storage system, such as a flash memory, a random access memory (RAM) for the temporary storage of information, and/or a read-only memory (ROM) for permanent storage of information. The memory 20 can also be an external storage system, such as a hard disk, a storage card, or a data storage medium.

In one embodiment, the communicator 40 is coupled with the processor 10 and communicates with the at least one equipment 2. The communicator 40 obtains data from the at least one equipment 2.

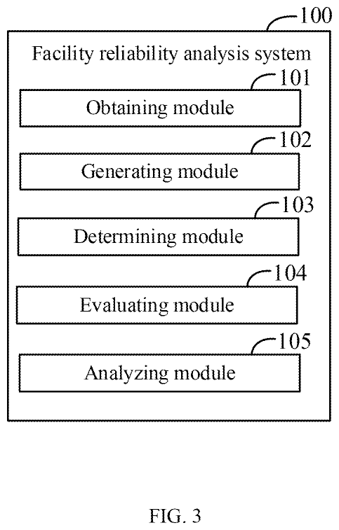

As illustrated in FIG. 3, the electronic device 1 runs a facility reliability analysis system 100. The facility reliability analysis system 100 at least includes an obtaining module 101, a generating module 102, a determining module 103, an evaluating module 104, and an analyzing module 105. The modules 101-105 can be collections of software instructions stored in the memory 20 of the electronic device 1 and executed by the processor 10. The modules 101-105 also can include functionality represented as hardware or integrated circuits, or as software and hardware combinations, such as a special-purpose processor or a general-purpose processor with special-purpose firmware.

The obtaining module 101 is configured to obtain data including alarms and warnings (hereinafter alarm data) from the at least one equipment 2.

In one embodiment, the obtaining module 101 obtains the alarm data transmitted by the at least one equipment 2 through the communicator 40. The alarm data includes, but is not limited to, a device name, an alarm category, and an alarm time set.

The generating module 102 is configured to form a first prediction parameter and a first algorithm model based on the alarm data and a first model.

In one embodiment, the first model can be a probability distribution model, such as any one of a Weibull distribution model, a normal distribution model, an exponential model, a logarithmic model, or other probability distribution models.

In detail, the generating module 102 generates a maximum likelihood function corresponding to the first model. The first model here can be a pre-selected model, which contains parameters to be determined. The parameters to be determined are not determined directly, but are estimated by the maximum likelihood function. Obtaining the maximum likelihood function is basically equivalent to obtaining the parameters to be determined of the first model. The maximum likelihood function contains undetermined parameters. The specific estimation method is to obtain unknown values in the maximum likelihood function based on an algorithm model, that is, calculate solutions of the undetermined parameters, and then input the solutions of the undetermined parameters into the maximum likelihood function, which can be regarded as obtaining the first model. The first model can be configured to make predictions based on the alarm data.

For example, the first model is taken as the Weibull distribution model, the maximum likelihood function of the Weibull distribution model is the following formula:

$${l}_{i} ( λ , β ) := ln {L}_{i} ( λ , β ) = N ln β - N β ln λ - {\sum }_{i = 1}^{N} {( \frac{{x}_{i}}{λ} )}^{β} + ( β - 1 ) {\sum }_{i = 1}^{N} ln {x}_{i} . \qquad formula ( 1 )$$

In the above formula (1), xᵢ is a time interval between alarms in the alarm data, N is the number of the time intervals between alarms, and λ and β are the undetermined parameters.

In detail, the generating module 102 further calculates the solutions of the undetermined parameters based on the alarm data and the algorithm model. In one embodiment, the generating module 102 sets initial parameters of the algorithm model, and then adjusts the initial parameters based on the alarm data until the initial parameters reach a preset constraint condition, so as to form the solutions of the undetermined parameters.

In one embodiment, the algorithm model can be optionally adopted as the Particle Swarm Optimization (PSO) algorithm, and the formula of the PSO algorithm is:

$$\vec{{v}_{i}} ( t + 1 ) = w \times \vec{{v}_{i}} ( t ) + {r}_{1} {c}_{1} ( \vec{{x}_{pBest}} - \vec{{x}_{i}} ( t ) ) + {r}_{2} {c}_{2} ( \vec{{x}_{gBest}} - \vec{{x}_{i}} ( t ) ) . \qquad formula ( 2 )$$

In the formula (2), w is an inertia weight, c₁ and c₂ are acceleration coefficients, and r₁ and r₂ are random numbers. The generating module 102 estimates the solutions of the undetermined parameters based on the alarm data and the PSO algorithm. The generating module 102 sets the alarm data as particles in the PSO algorithm, sets respectively the undetermined parameters λ and β as a speed and a position of the particles in the PSO algorithm, initializes the values of the undetermined parameters, and calculates a maximum likelihood function value in the formula (1) based on the initialized values. A historical optimal position of the particles and a global optimal position of the group is calculated based on the formula (2). The generating module 102 adjusts the values of the undetermined parameters based on the historical optimal position and the global optimal position, continues to calculate the maximum likelihood function value in the formula (1) based on the adjusted value, and updates the historical optimal position of the particles and the global optimal position of the group based on the formula (2). The generating module 102 iterates the above process until the global optimal position reaches the preset constraint condition, that is, when it becomes less than a preset threshold, and outputs the velocity and position of the particles at this time as the solutions of the undetermined parameters.

In other embodiments, the algorithm model may also be a BP neural network model. The generating module 102 estimates the solutions of the undetermined parameters based on the alarm data and the BP neural network model. The BP neural network model has an input layer, a hidden layer, and an output layer. The generating module 102 takes the alarm data as the input layer, sets the values of the undetermined parameters as weights of the hidden layer and the output layer, and calculates output values based on the input alarm data and the weights. If the output values do not meet the preset constraint condition, that is, when an error greater than the preset threshold is found between the output value and an expected value, the weights are adjusted. The generating module 102 continues to calculate the output values based on the input alarm data and the adjusted weights, and iterates the above process until the output values meet the preset constraint condition. That is, when the error between the output value and the expected value is less than or equal to the preset threshold, the weights at this time are taken as the solutions of the undetermined parameters.

In other embodiments, the algorithm model may also be a fish school algorithm (AFSA), a genetic algorithm, or the like.

In detail, the generating module 102 further generates a first algorithm model based on the solutions of the undetermined parameters and the maximum likelihood function. In one embodiment, the generating module 102 generates the first algorithm model by inputting the solutions of the undetermined parameters into the maximum likelihood function.

In detail, the generating module 102 further generates a first prediction parameter based on the first algorithm model and an adaptation model. In one embodiment, the adaptation model is a preset Akaike information criterion (AIC), and the following formula of the AIC is:

AIC=−2 log(L)+2k formula (3).

In the formula (3), L is a most approximate value obtained by the formula (1) based on the solutions of the undetermined parameters, k is the number of the undetermined parameters, and k=2 in the embodiment. The generating module 102 inputs the output values of the first algorithm model based on the undetermined parameter into the formula (3), so as to generate the first prediction parameter.

The generating module 102 further generates a second prediction parameter and a second algorithm model based on the alarm data and a second model.

In one embodiment, the second model can be a probability distribution model, such as any one of a Weibull distribution model, a normal distribution model, an exponential model, and a logarithmic model that is different from the first model.

In one embodiment, the generating module 102 generates the second prediction parameter and the second algorithm model based on the alarm data and the second model using the method as described above.

In one embodiment, the generating module 102 further generates the second prediction parameter based on the second algorithm model and the Akaike information criterion (AIC).

The determining module 103 is configured to determine that the first algorithm model is better than the second algorithm model based on a judgment model, the first prediction parameter, and the second prediction parameter.

In one embodiment, the judgment model is to determine a relationship of magnitude between the first prediction parameter and the second prediction parameter by comparing the first prediction parameter with the second prediction parameter. That is, if the determining module 103 determines that the first prediction parameter is less than or equal to the second prediction parameter based on the judgment model, the first algorithm model is determined as being better than the second algorithm model.

If the first algorithm model is better than the second algorithm model, the evaluating module 104 is configured to generate an evaluation index based on the first algorithm model, so as to evaluate the reliability of the at least one equipment 2 based on the evaluation index.

In one embodiment, if the first algorithm model is better than the second algorithm model, the evaluating module 104 extracts calculation parameters of the first algorithm model, and inputs the calculation parameters into a reliability model, to generate the evaluation index. The evaluation index is an average alarm time interval, that is, a Mean Time To Failure (hereinafter “MTTF”).

In one embodiment, the formula of the reliability model is:

$$MTTF = λ Γ ( 1 + \frac{1}{k} ) . \qquad formula ( 4 )$$

The evaluating module 104 inputs the calculation parameters into the formula (4) to calculate the MTTF.

It should be noted that the time set based on each alarm category can only provide the time when the alarm occurred, and does not indicate the reliability of facility, the average alarm time interval is used as an evaluation index for the reliability of facility, which can provide a direct standard for users to evaluate the reliability of facility.

In one embodiment, the alarm data specifically includes a first alarm category, a second alarm category, a first time set corresponding to the first alarm category, and a second time set corresponding to the second alarm category.

If the first algorithm model is better than the second algorithm model, the evaluating module 104 further generates a first MTTF corresponding to the first alarm category based on the first time set and the first algorithm model.

If the first algorithm model is better than the second algorithm model, the evaluating module 104 further generates a second MTTF corresponding to the second alarm category based on the second time set and the first algorithm model.

The evaluating module 104 further generates the MTTF of the equipment 2 based on the first MTTF and the second MTTF.

The analyzing module 105 is configured to sort a number of alarm categories based on the evaluation index and evaluate the reliability of facility.

After a number of alarm categories of the equipment are obtained, the equipment can further be sorted, and the reliability of facility can be evaluated from a perspective of a facility level.

For example, a machine has two exemplary overheating faults (i.e., the first alarm category) and tool breakage faults (i.e., the second alarm category). Based on the calculated first algorithm model, the analyzing module 105 inputs a historical fault time set (i.e., the first time set) of the overheating fault into the first algorithm model, the first time set is exemplified as (1:00,4:00,7:00,10:00), and calculates the MTTF of the overheating fault to be 3 hours. The analyzing module 105 inputs a historical failure time set (the second time set) of tool breakage faults into the first algorithm model, the second time set is exemplified as (1:00,6:00,8:00,10:00), and calculates the MTTF of the tool breakage faults to be 2.5 hours. The MTTF the machine is thus determined to be 2.5 hours, that is, the machine is required to be repaired for overheating faults and tool breakage faults every 2.5 hours, and a priority of overheating fault repairs will be lower than a priority of tool breakage fault repair, the reliability of facility is thus determined.

The related art more uses a mean time of failure as an index for planning fault overhaul. The mean time of failure method can be understood as a moving average method. Still taking the above process as an example, the mean time of failure for overheating faults is 3 hours, the calculation method is to divide a total failure time of the first time set by the number of intervals between similar failures in the total time, for example, (1:00,4:00,7:00,10:00) is (3+3+3)/3=3 hours. In the same way, the mean time of the tool breakage faults is also 3 hours. If 3 hours is the period used as the time interval for overheating faults and tool breakage faults to be repaired, the probability of causing downtime will be much greater than 2.5 hours calculated by the technical solution of the present disclosure. At the same time, if a shortest time interval of the failure (the shortest time interval of the above process occurs when the tool breakage fault occurs between 6:00-8:00, which is 2 hours) is used as an index for planning fault overhaul, the cost of maintenance is greatly increased, and the optimal time interval of overhaul cannot be determined.

In one embodiment, the analyzing module 105 sorts a number of devices 2 based on the MTTF of each equipment 2. The sorting is from short to long, and sorts a number of alarm categories in sequence based on the MTTF of each alarm category from short to long. The user can simply and directly understand the frequency of different facility alarms and the frequency of different alarm categories based on the sorting, so as to be timely aware of the failure of equipment, and predict the time when the facility will alarm. Maintenance can be performed in advance based on the predicted time when the alarm occurs, actions such as maintenance in advance for preventing downtime can be made, which increases a utilization rate of the machine.

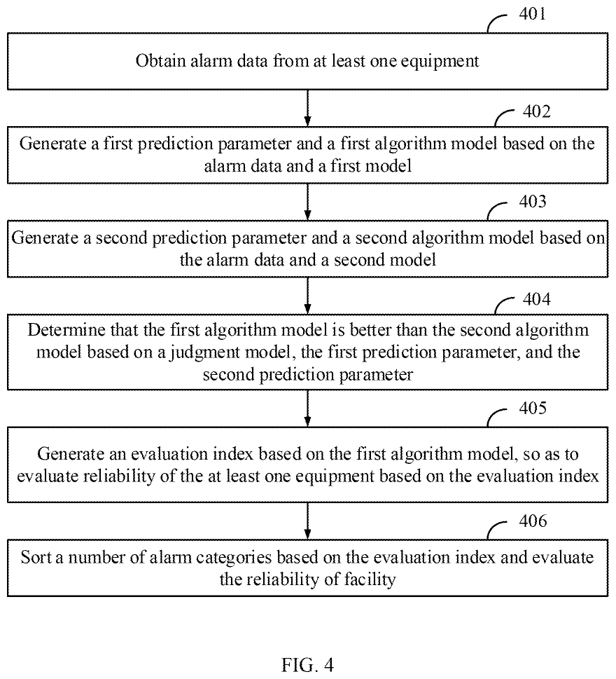

FIG. 4 illustrates a flowchart of an embodiment of a method for analyzing reliability of facility. The method is provided by way of example, as there are a variety of ways to carry out the method. The method described below can be carried out using the configurations illustrated in FIGS. 1-3, for example, and various elements of these figures are referenced in explaining the example method. Each block shown in FIG. 4 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 401.

At block 401, the obtaining module 101 obtains alarm data from the at least one equipment 2.

In one embodiment, the obtaining module 101 obtains the alarm data transmitted by the at least one equipment 2 through the communicator 40. The alarm data includes, but is not limited to, a device name, an alarm category, and an alarm time set.

At block 402, the generating module 102 generates a first prediction parameter and a first algorithm model based on the alarm data and a first model.

In one embodiment, the first model can be a probability distribution model, such as any one of a Weibull distribution model, a normal distribution model, an exponential model, a logarithmic model, or other probability distribution models.

In detail, the generating module 102 generates a maximum likelihood function corresponding to the first model, based on the first model. The first model here can be a pre-selected model, which contains parameters to be determined. The parameters to be determined are not determined directly, but are estimated by the maximum likelihood function. Obtaining the maximum likelihood function is basically equivalent to obtaining the parameters to be determined of the first model. The maximum likelihood function contains undetermined parameters. The specific estimation method is to obtain unknown values in the maximum likelihood function based on an algorithm model, that is, calculate solutions of the undetermined parameters, and then input the solutions of the undetermined parameters into the maximum likelihood function, which can be regarded as obtaining the first model, the first model can be configured to make predictions based on the alarm data.

For example, the first model is taken as the Weibull distribution model, the maximum likelihood function of the Weibull distribution model is the following formula:

$${l}_{i} ( λ , β ) := ln {L}_{i} ( λ , β ) = N ln β - N β ln λ - {\sum }_{i = 1}^{N} {( \frac{{x}_{i}}{λ} )}^{β} + ( β - 1 ) {\sum }_{i = 1}^{N} ln {x}_{i} . \qquad formula ( 1 )$$

In the above formula (1), xᵢ is a time interval of alarm occurrence in the alarm data, N is the number of the time intervals of alarm occurrence, and λ and β are the undetermined parameters.

In detail, the generating module 102 further calculates the solutions of the undetermined parameters based on the alarm data and the algorithm model. In one embodiment, the generating module 102 sets initial parameters of the algorithm model, and then adjusts the initial parameters based on the alarm data until the initial parameters reach a preset constraint condition, so as to form the solutions of the undetermined parameters.

In one embodiment, the algorithm model can be optionally adopted as the Particle Swarm Optimization (PSO) algorithm, and the formula of the PSO algorithm is:

$$\vec{{v}_{i}} ( t + 1 ) = w \times \vec{{v}_{i}} ( t ) + {r}_{1} {c}_{1} ( \vec{{x}_{pBest}} - \vec{{x}_{i}} ( t ) ) + {r}_{2} {c}_{2} ( \vec{{x}_{gBest}} - \vec{{x}_{i}} ( t ) ) . \qquad formula ( 2 )$$

In the formula (2), w is an inertia weight, c₁ and c₂ are acceleration coefficients, and r₁ and r₂ are random numbers. The generating module 102 estimates the solutions of the undetermined parameters based on the alarm data and the PSO algorithm. The generating module 102 sets the alarm data as particles in the PSO algorithm, sets respectively the undetermined parameters λ and β as a speed and a position of the particles in the PSO algorithm, initializes the values of the undetermined parameters, and calculates a maximum likelihood function value in the formula (1) based on the initialized values. A historical optimal position of the particles and a global optimal position of the group is calculated based on the formula (2). The generating module 102 adjusts the values of the undetermined parameters based on the historical optimal position and the global optimal position, continues to calculate the maximum likelihood function value in the formula (1) based on the adjusted value, and updates the historical optimal position of the particles and the global optimal position of the group based on the formula (2). The generating module 102 iterates the above process until the global optimal position reaches the preset constraint condition, that is, when it becomes is less than a preset threshold, and outputs the velocity and position of the particles at this time as the solutions of the undetermined parameters.

In other embodiments, the algorithm model may also be a BP neural network model. The generating module 102 estimates the solutions of the undetermined parameters based on the alarm data and the BP neural network model. The BP neural network model has an input layer, a hidden layer, and an output layer. The generating module 102 takes the alarm data as the input layer, sets the values of the undetermined parameters as weights of the hidden layer and the output layer, and calculates output values based on the input alarm data and the weight. If the output values do not meet the preset constraint condition, that is, when an error greater than the preset threshold is found between the output value and an expected value, the weights are adjusted. The generating module 102 continues to calculate the output values based on the input alarm data and the adjusted weight, and iterates the above process until the output values meet the preset constraint condition. That is, when the error between the output value and the expected value is less than or equal to the preset threshold, the weights at this time are taken as the solutions of the undetermined parameters.

In other embodiments, the algorithm model may also be a fish school algorithm (AFSA), genetic algorithm, or the like.

In detail, the generating module 102 further generates a first algorithm model based on the solutions of the undetermined parameters and the maximum likelihood function. In one embodiment, the generating module 102 generates the first algorithm model by inputting the solutions of the undetermined parameters into the maximum likelihood function.

In detail, the generating module 102 further generates a first prediction parameter based on the first algorithm model and an adaptation model. In one embodiment, the adaptation model is a preset Akaike information criterion (AIC), and the following formula of the AIC is:

AIC=−2 log(L)+2k formula (3).

In the formula (3), L is a most approximate value obtained by the formula (1) based on the solutions of the undetermined parameters, k is the number of the undetermined parameters, and k=2 in the embodiment. The generating module 102 inputs the output values of the first algorithm model based on the undetermined parameter into the formula (3), so as to generate the first prediction parameter.

At block 403, the generating module 102 further generates a second prediction parameter and a second algorithm model based on the alarm data and a second model.

In one embodiment, the second model can be a probability distribution model, such as any one of a Weibull distribution model, a normal distribution model, an exponential model, and a logarithmic model that is different from the first model.

In one embodiment, the generating module 102 generates the second prediction parameter and the second algorithm model based on the alarm data and the second model using the method as described above.

In one embodiment, the generating module 102 further generates the second prediction parameter based on the second algorithm model and the Akaike information criterion (AIC).

At block 404, the determining module 103 is configured to determine that the first algorithm model is better than the second algorithm model based on a judgment model, the first prediction parameter, and the second prediction parameter.

In one embodiment, the judgment model is to determine a relationship of magnitude between the first prediction parameter and the second prediction parameter by comparing the first prediction parameter with the second prediction parameter. That is, if the determining module 103 determines that the first prediction parameter is less than or equal to the second prediction parameter based on the judgment model, the first algorithm model is determined as being better than the second algorithm model.

At block 405, if the first algorithm model is better than the second algorithm model, the evaluating module 104 generates an evaluation index based on the first algorithm model, so as to evaluate the reliability of the at least one equipment 2 based on the evaluation index.

In one embodiment, if the first algorithm model is better than the second algorithm model, the evaluating module 104 extracts calculation parameters of the first algorithm model, and inputs the calculation parameters into a reliability model, to generating the evaluation index. The evaluation index is an average alarm time interval, that is, a Mean Time To Failure (hereinafter “MTTF”).

In one embodiment, the formula of the reliability model is:

$$MTTF = λ Γ ( 1 + \frac{1}{k} ) . \qquad formula ( 4 )$$

The evaluating module 104 inputs the calculation parameters into the formula (4) to calculate the MTTF.

It should be noted that, the time set based on each alarm category can only provide the time when the alarm occurred, and does not indicate the reliability of facility, the average alarm time interval is used as an evaluation index for the reliability of facility, which can provide a direct standard for users to evaluate the reliability of facility.

In one embodiment, the alarm data specifically includes a first alarm category, a second alarm category, a first time set corresponding to the first alarm category, and a second time set corresponding to the second alarm category.

If the first algorithm model is better than the second algorithm model, the evaluating module 104 further generates a first MTTF corresponding to the first alarm category based on the first time set and the first algorithm model.

If the first algorithm model is better than the second algorithm model, the evaluating module 104 further generates a second MTTF corresponding to the second alarm category based on the second time set and the first algorithm model.

The evaluating module 104 further generates the MTTF of the equipment 2 based on the first MTTF and the second MTTF.

At block 406, the analyzing module 105 sorts a number of alarm categories based on the evaluation index and evaluate the reliability of facility.

After a number of alarm categories of the equipment are obtained, the equipment can further be sorted, and the reliability of facility can be evaluated from a perspective of a facility level.

For example, a machine has two exemplary overheating faults (i.e., the first alarm category) and tool breakage faults (i.e., the second alarm category). Based on the calculated first algorithm model, the analyzing module 105 inputs a historical fault time set (i.e., the first time set) of the overheating fault into the first algorithm model, the first time set is exemplified as (1:00,4:00,7:00,10:00), and calculates the MTTF of the overheating fault to be 3 hours. The analyzing module 105 inputs a historical failure time set (the second time set) of tool breakage faults into the first algorithm model, the second time set is exemplified as (1:00,6:00,8:00,10:00), and calculates the MTTF of the tool breakage faults to be 2.5 hours. The MTTF the machine is thus determined to be 2.5 hours, that is, the machine is required to be repaired for overheating faults and tool breakage faults every 2.5 hours, and a priority of overheating fault repairs will be lower than a priority of tool breakage fault repair, the reliability of facility is thus determined.

The related art more uses a mean time of failure as an index for planning fault overhaul. The mean time of failure method can be understood as a moving average method. Still taking the above process as an example, the mean time of failure for overheating faults is 3 hours, the calculation method is to divide a total failure time of the first time set by the number of intervals between similar failures in the total time, for example, (1:00,4:00,7:00,10:00) is (3+3+3)/3=3 hours. In the same way, the mean time of the tool breakage faults is also 3 hours. If 3 hours is the period used as the time interval for overheating faults and tool breakage faults to be repaired, the probability of causing downtime will be much greater than 2.5 hours calculated by the technical solution of the present disclosure. At the same time, if a shortest time interval of the failure (the shortest time interval of the above process occurs when the tool breakage fault occurs between 6:00-8:00, which is 2 hours) is used as an index for planning fault overhaul, the cost of maintenance is greatly increased, and the optimal time interval of overhaul cannot be determined.

In one embodiment, the analyzing module 105 sorts a number of devices 2 based on the MTTF of each equipment 2. The sorting is from short to long, and sorts a number of alarm categories in sequence based on the MTTF of each alarm category from short to long. The user can simply and directly understand the frequency of different facility alarms and the frequency of different alarm categories based on the sorting, so as to be timely aware of the failure of equipment, and predict the time when the facility will alarm. Maintenance can be performed in advance based on the predicted time when the alarm occurs, actions such as maintenance in advance for preventing downtime can be made, which increases a utilization rate of the machine.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

What is claimed is:

1. An electronic device for analyzing reliability of facility, comprising:
a communicator configured to
obtain alarm data from at least one equipment;
a processor coupled to the communicator; and
a memory coupled to the processor and storing instructions, the processor is configured to execute the instructions to:
generate a first prediction parameter and a first algorithm model based on the alarm data and a first model;
generate a second prediction parameter and a second algorithm model based on the alarm data and a second model;
determine that the first algorithm model is better than the second algorithm model based on a judgment model, the first prediction parameter, and the second prediction parameter; and
generate an evaluation index based on the first algorithm model, so as to evaluate the reliability of the at least one equipment based on the evaluation index, in response that the first algorithm model is determined to be better than the second algorithm model.

2. The electronic device of claim 1, wherein the processor is further configured to execute the instructions to:
generate a maximum likelihood function corresponding to the first model based on the first model, wherein the maximum likelihood function comprises undetermined parameters;
generate solutions of the undetermined parameters based on the alarm data and an algorithm model;
generate the first algorithm model based on the solutions of the undetermined parameters and the maximum likelihood function; and
generate the first prediction parameter based on the first algorithm model and an adaption model.

3. The electronic device of claim 2, wherein the processor is further configured to execute the instructions to:
set initial parameters of the algorithm model; and
generate the solutions of the undetermined parameters by adjusting the initial parameters based on the alarm data until the initial parameters meet a preset constraint condition.

4. The electronic device of claim 1, wherein the processor is further configured to execute the instructions to:
generate the first prediction parameter based on the first algorithm model and a preset Akaike information criterion (AIC);
generate the second prediction parameter based on the second algorithm model and the preset AIC;
determine that the first prediction parameter is less than or equal to the second prediction parameter based on the judgement model; and
determine that the first algorithm model is better than the second algorithm model, in response that the first prediction parameter is determined to be less than or equal to the second prediction parameter.

5. The electronic device of claim 1, wherein the processor is further configured to execute the instructions to:
extract calculation parameters of the first algorithm model, in response that the first algorithm model is determined to be better than the second algorithm model; and
generate the evaluation index by inputting the calculation parameters to a reliability model.

6. The electronic device of claim 1, wherein the alarm data comprises a first alarm category, a second alarm category, a first time set corresponding to the first alarm category, and a second time set corresponding to the second alarm category, the evaluation index comprises a Mean Time To Failure (MTTF),
the processor is further configured to execute the instructions to:
generate a first MTTF corresponding to the first alarm category based on the first time set and the first algorithm model, in response that the first algorithm model is better than the second algorithm model;
generate a second MTTF corresponding to the second alarm category based on the second time set and the first algorithm model, in response that the first algorithm model is better than the second algorithm model; and
generate a MTTF of the at least one equipment based on the first MTTF and the second MTTF.

7. A method for analyzing reliability of facility implemented in an electronic device comprising:
obtaining alarm data from at least one equipment;
generating a first prediction parameter and a first algorithm model based on the alarm data and a first model;
generating a second prediction parameter and a second algorithm model based on the alarm data and a second model;
determining that the first algorithm model is better than the second algorithm model based on a judgment model, the first prediction parameter, and the second prediction parameter; and
generating an evaluation index based on the first algorithm model, so as to evaluate the reliability of the at least one equipment based on the evaluation index, in response that the first algorithm model is determined to be better than the second algorithm model.

8. The method of claim 7, wherein generating a first prediction parameter and a first algorithm model comprises:
generating a maximum likelihood function corresponding to the first model based on the first model, wherein the maximum likelihood function comprises undetermined parameters;
generating solutions of the undetermined parameters based on the alarm data and an algorithm model;
generating the first algorithm model based on the solutions of the undetermined parameters and the maximum likelihood function; and
generating the first prediction parameter based on the first algorithm model and an adaption model.

9. The method of claim 8, further comprising:
setting initial parameters of the algorithm model; and
generating the solutions of the undetermined parameters by adjusting the initial parameters based on the alarm data until the initial parameters meet a preset constraint condition.

10. The method of claim 7, wherein determining that the first algorithm model is better than the second algorithm model comprises:
generating the first prediction parameter based on the first algorithm model and a preset Akaike information criterion (AIC);
generating the second prediction parameter based on the second algorithm model and the preset AIC;
determining that the first prediction parameter is less than or equal to the second prediction parameter based on the judgement model; and
determining that the first algorithm model is better than the second algorithm model, in response that the first prediction parameter is determined to be less than or equal to the second prediction parameter.

11. The method of claim 7 wherein generating an evaluation index comprises:
extracting calculation parameters of the first algorithm model, in response that the first algorithm model is determined to be better than the second algorithm model; and
generating the evaluation index by inputting the calculation parameters to a reliability model.

12. The method of claim 7, wherein the alarm data comprises a first alarm category, a second alarm category, a first time set corresponding to the first alarm category, and a second time set corresponding to the second alarm category, the evaluation index comprises a Mean Time To Failure (MTTF),
the method further comprising:
generating a first MTTF corresponding to the first alarm category based on the first time set and the first algorithm model, in response that the first algorithm model is better than the second algorithm model;
generating a second MTTF corresponding to the second alarm category based on the second time set and the first algorithm model, in response that the first algorithm model is better than the second algorithm model; and
generating a MTTF of the at least one equipment based on the first MTTF and the second MTTF.

13. An electronic device for analyzing reliability of facility, comprising:
a processor coupled to the communicator; and
a memory coupled to the processor and storing instructions, the processor is configured to execute the instructions to:
obtain alarm data from at least one equipment;
generate a first prediction parameter and a first algorithm model based on the alarm data and a first model;
generate a second prediction parameter and a second algorithm model based on the alarm data and a second model;
determine that the first algorithm model is better than the second algorithm model based on a judgment model, the first prediction parameter, and the second prediction parameter; and
generate an evaluation index based on the first algorithm model, so as to evaluate the reliability of the equipment based on the evaluation index, in response that the first algorithm model is determined to be better than the second algorithm model.

14. The electronic device of claim 13, wherein the processor is further configured to execute the instructions to:
generate a maximum likelihood function corresponding to the first model based on the first model, wherein the maximum likelihood function comprises undetermined parameters;
generate solutions of the undetermined parameters based on the alarm data and an algorithm model;
generate the first algorithm model based on the solutions of the undetermined parameters and the maximum likelihood function; and
generate the first prediction parameter based on the first algorithm model and an adaption model.

15. The electronic device of claim 14, wherein the processor is further configured to execute the instructions to:
set initial parameters of the algorithm model; and
generate the solutions of the undetermined parameters by adjusting the initial parameters based on the alarm data until the initial parameters meet a preset constraint condition.

16. The electronic device of claim 13, wherein the processor is further configured to execute the instructions to:
generate the first prediction parameter based on the first algorithm model and a preset Akaike information criterion (AIC);
generate the second prediction parameter based on the second algorithm model and the preset AIC;
determine that the first prediction parameter is less than or equal to the second prediction parameter based on the judgement model; and
determine that the first algorithm model is better than the second algorithm model, in response that the first prediction parameter is determined to be less than or equal to the second prediction parameter.

17. The electronic device of claim 13, wherein the processor is further configured to execute the instructions to:
extract calculation parameters of the first algorithm model, in response that the first algorithm model is determined to be better than the second algorithm model; and
generate the evaluation index by inputting the calculation parameters to a reliability model.

18. The electronic device of claim 13, wherein the alarm data comprises a first alarm category, a second alarm category, a first time set corresponding to the first alarm category, and a second time set corresponding to the second alarm category, the evaluation index comprises a Mean Time To Failure (MTTF),
the processor is further configured to execute the instructions to:
generate a first MTTF corresponding to the first alarm category based on the first time set and the first algorithm model, in response that the first algorithm model is better than the second algorithm model;
generate a second MTTF corresponding to the second alarm category based on the second time set and the first algorithm model, in response that the first algorithm model is better than the second algorithm model; and
generate a MTTF of the at least one equipment based on the first MTTF and the second MTTF.
